(19) United States
(12) Patent Application Publication
(10) Pub. No.: US 2008/0265661 A1
(43) Pub. Date: Oct. 30, 2008

(54) DRIVESHAFT BOOT PROTECTOR

(75) Inventor: Bryan M. HARPER, Sharpsburg, GA (US)

Correspondence Address: YAMAHA MOTOR MANUFACTURING CO.;C/O KEATING & BENNETT, LLP, 1800 Alexander Bell Drive, SUITE 200, Reston, VA, 20191, US

(73) Assignee: YAMAHA MOTOR MANUFACTURING CORPORATION OF AMERICA, Newnan, GA (US)

(21) Appl. No.: 11/742,162

(22) Filed: Apr. 30, 2007

(51) Int. Cl. B60B 35/16

(52) U.S. Cl. 301/137

(57) ABSTRACT

A driveshaft boot protector includes a curved main body, fastening members attached to the curved main body and extending from a main surface thereof, and wall members extending from the main surface of the main body. The fastening members are arranged to be attached to a knuckle assembly of a suspension system for a vehicle. The fastening members are either snap fit members which engage corresponding structures on the knuckle assembly or threaded fasteners. The driveshaft boot protector is removably attached to the knuckle assembly.

### BACKGROUND OF THE INVENTION

1. Field of the Invention

The present invention relates to a driveshaft boot protector for a vehicle, and more particularly, to a lightweight driveshaft boot protector for a vehicle which provides complete coverage of a driveshaft boot when a vehicle is turning or when the suspension of the vehicle is compressed.

2. Description of the Related Art

Conventional driveshaft boot protectors have suffered from various problems, including providing incomplete coverage and protection of the driveshaft boot when a vehicle is turning or when the suspension of the vehicle is compressed, being made of expensive materials, being excessively heavy, and being integral with components of the suspension so as to prevent easy replacement and so as to prevent mounting of the driveshaft boot protector on an existing suspension.

U.S. Pat. No. 6,568,497 discloses a conventional protective structure for a driveshaft boot. The protective structure disclosed in U.S. Pat. No. 6,568,497 is shown in FIG. 7.

As shown in FIG. 7, the knuckle member 24 supports a constant velocity joint shaft 22, and defines a portion of a suspension system. The knuckle member 24 includes a portion 33 for supporting a driven shaft 30 of the constant velocity joint shaft 22, a portion 34 for connecting to a lower arm 25, a portion 35 for supporting a strut (not shown), and a covering portion 28 for protecting a joint portion 23 of the constant velocity joint shaft 22 and a boot 27 provided on the joint portion 23. The driven shaft support portion 33, the lower arm connecting portion 34, the strut support portion 35, and the covering portion 28 are molded together out of an aluminum alloy into an integral body. In other words, the knuckle member 24 is formed as a single aluminum alloy part.

However, the knuckle member 24 disclosed in U.S. Pat. No. 6,568,497 and as shown in FIG. 7 suffers from the following problems. First, since the covering portion 28 is integrally formed with the driven shaft support portion 33, the lower arm connecting portion 34, and the strut support portion 35, the covering portion 28 is necessarily made of a metal, such as an aluminum alloy. Consequently, the covering portion 28 cannot be made of a different material from the driven shaft support portion 33, the lower arm connecting portion 34, and the strut support portion 35. This prevents the covering portion 28 from being made of a material that is lighter than aluminum. Thus, the weight of the covering portion 28 cannot be sufficiently reduced. In addition, the covering portion 28 cannot be made of a material having an impact resistance that is superior to that of aluminum.

Second, since the covering portion 28 is integrally formed with the driven shaft support portion 33, the lower arm connecting portion 34, and the strut support portion 35, the knuckle member 24 must be specially designed and manufactured. Thus, the manufacturing cost of a vehicle including such a knuckle member 24 is increased. In addition, the covering portion cannot be fitted to already existing knuckle members and vehicles.

Third, due to the integral design of the covering portion 28, if the covering portion 28 is broken or otherwise damaged, it cannot be easily replaced. In fact, if the covering portion 28 is broken or damaged, the entire knuckle member 24 including the covering portion 28 must be replaced, which substantially increases the maintenance cost of the vehicle.

U.S. Pat. No. 6,692,366 discloses a shield that is attached to A-arms of a suspension system of a vehicle, and which protects various components of the suspension system. However, the shield of U.S. Pat. No. 6,692,366 provides incomplete coverage and protection of a driveshaft boot protector, when the vehicle is turning or when the suspension of the vehicle is compressed. This is due to the fact that the relative positions of the A-arms having the shield attached thereto and the knuckle assembly change during turning and during suspension compression, which causes the driveshaft boot protector to be exposed when the vehicle is turned or when the suspension system is compressed. Thus, the shield of U.S. Pat. No. 6,692,366 does not provide sufficient protection of the driveshaft boot protector.

### SUMMARY OF THE INVENTION

To overcome the problems described above, preferred embodiments of the present invention provide a lightweight, low cost driveshaft boot protector which allows the boot to be completely protected at all times, including during turning of the vehicle, and during suspension travel.

A driveshaft boot protector according to a preferred embodiment of the present invention includes a main body having a central opening and arranged to at least partially surround the driveshaft boot of a knuckle assembly, and at least one fastening member extending from a main surface of the main body and being arranged to be removably attached to the knuckle assembly.

The at least one fastening member preferably includes a leg portion that extends from the main surface of the main body and a foot portion that extends substantially perpendicular to the leg portion, the foot portion being arranged to be engageable with a corresponding structure on the knuckle assembly.

The at least one fastening member preferably includes a reinforcing member that extends along the leg portion to increase the rigidity of the at least one fastening member.

The at least one fastening member preferably includes at least one first fastening member, at least one second fastening member, and at least one third fastening member each having a different configuration from one another.

The at least one second fastening member preferably has a substantially cylindrical shape extending from the main surface of the main body into which a fastener can be inserted.

The at least one third fastening member preferably includes at least two opposed arm members and a web extending between the arms. Each of the at least two opposed arm members preferably includes an end portion that is curved toward the other of the two opposed arm members and are arranged to be engageable with an arm member of the knuckle assembly.

The driveshaft boot protector preferably further includes at least one wall member extending from the main surface of the main body and being disposed around at least a portion of the periphery of the central opening in the main body.

A suspension system according to another preferred embodiment of the present invention includes a knuckle assembly and the driveshaft boot protector described above.

A vehicle according to another preferred embodiment includes a suspension system which includes a knuckle assembly and the driveshaft boot protector described above.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of the driveshaft boot protector according to a preferred embodiment of the present invention.

FIG. 2 is a top view of the driveshaft boot protector shown in FIG. 1 attached to a knuckle assembly.

FIG. 3 is a perspective view of a driveshaft boot protector according to another preferred embodiment of the present invention.

FIG. 4 is a side view of the driveshaft boot protector shown in FIG. 1.

FIG. 5 is a side view of the driveshaft boot protector shown in FIG. 1.

FIG. 6 is a perspective view of the driveshaft boot protector shown in FIG. 1 attached to a knuckle assembly.

FIG. 7 is a side view of a driveshaft boot protector according to the related art.

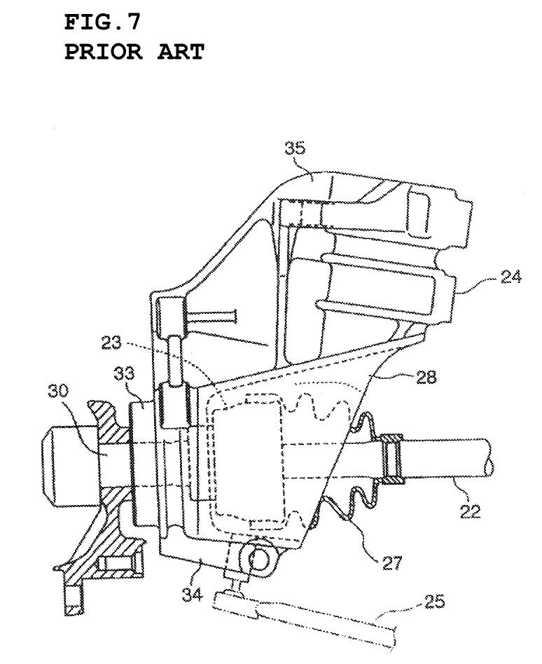

### DETAILED DESCRIPTION OF PREFERRED EMBODIMENTS

Preferred embodiments of the present invention will be described below with reference to the drawings.

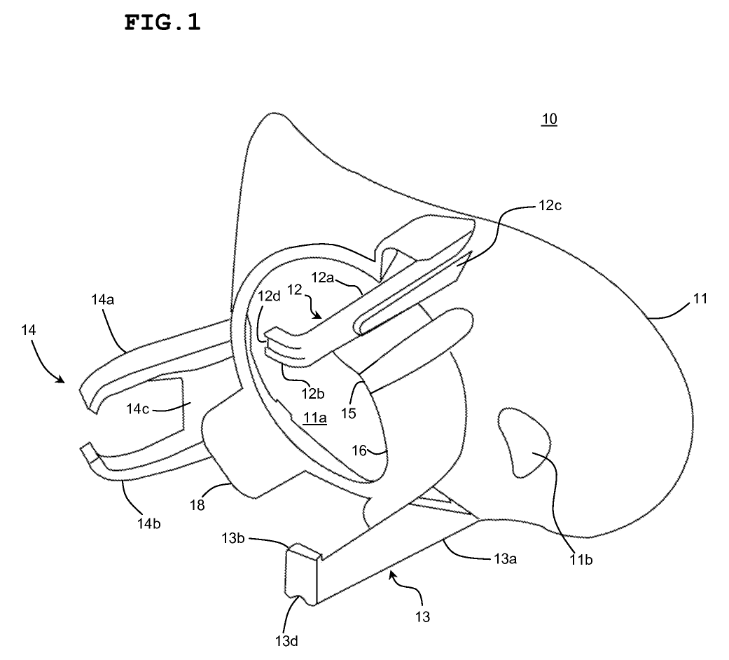

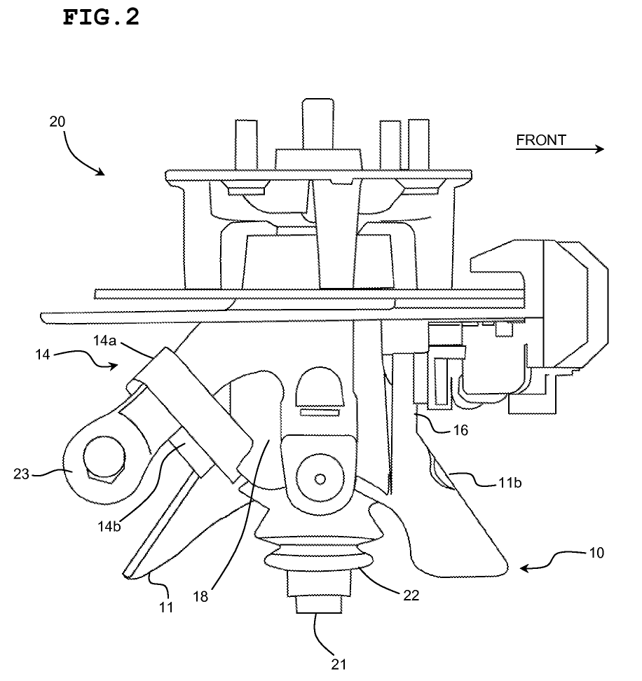

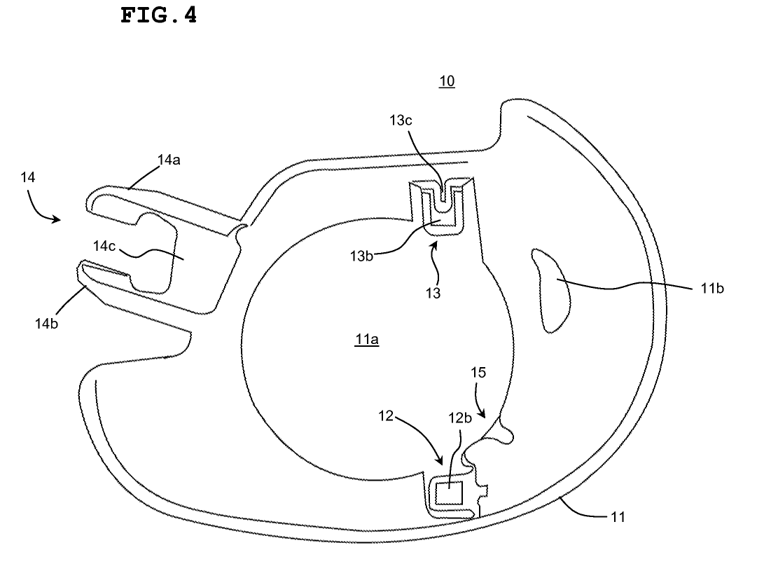

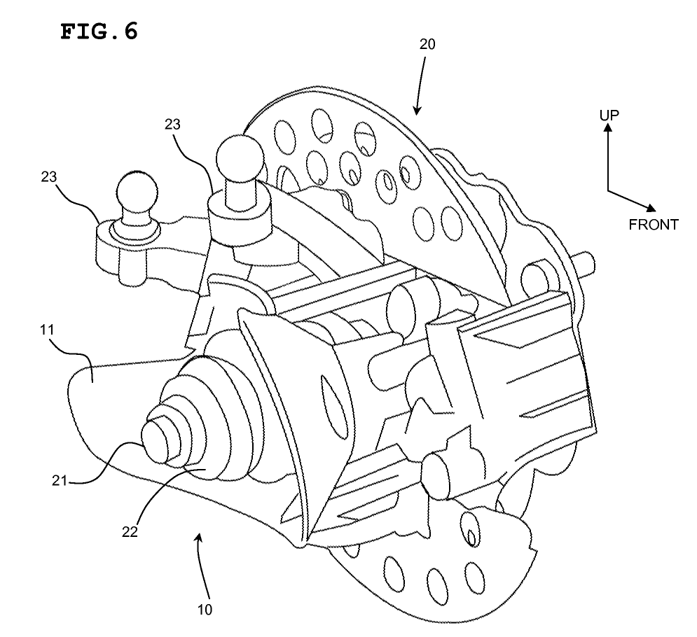

As shown in FIGS. 1, 4, and 5, the driveshaft boot protector 10 includes a curved main body 11 having an opening 11a in a central region thereof. As shown in FIGS. 2 and 6, a driveshaft 21 and a boot 22 of a knuckle assembly 20 extend through the opening 11a. The curved main body 11 is configured to surround and protect the boot 22. Although the main body 11 of the present preferred embodiment has a curved shape, any suitable shape may be used. The main body 11 includes a depression 11b for avoiding interference of the driveshaft boot protector 10 with a brake line or other suspension elements (not shown). The depression 11b is not always required, and instead, depends on the specific design of the vehicle, the knuckle assembly, and the driveshaft boot protector.

A plurality of fastening members 12, 13, 14, and 15 are attached to and extend from a main surface of the main body 11. As shown in FIGS. 2 and 6, the driveshaft boot protector 10 is removably attached to the knuckle assembly 20 by the fastening members 12, 13, 14, and 15, such that the driveshaft boot protector 10 can be selectively attached to and removed from the knuckle assembly 20 to facilitate removal and replacement of the driveshaft boot protector 10.

The fastening member 12 includes a leg portion 12a and a foot portion 12b that extends substantially perpendicular to the leg portion 12a. The foot portion 12a is preferably configured to be snap fit into a corresponding structure (not shown) on the knuckle assembly 20 shown in FIGS. 2 and 6 so as to secure the driveshaft boot protector 10 on the knuckle assembly. In this preferred embodiment, the foot portion 12b preferably has a substantially rectangular shape. However, the foot portion 12b may have any suitable shape. The foot portion 12b includes a groove 12d that extends along the bottom of the foot portion 12b. The groove 12d is provided so as to maintain a constant wall thickness, which is preferable for injection molding of the driveshaft boot protector 10. The foot portion 12b and the groove 12d are configured so as to snugly fit against the knuckle assembly 20.

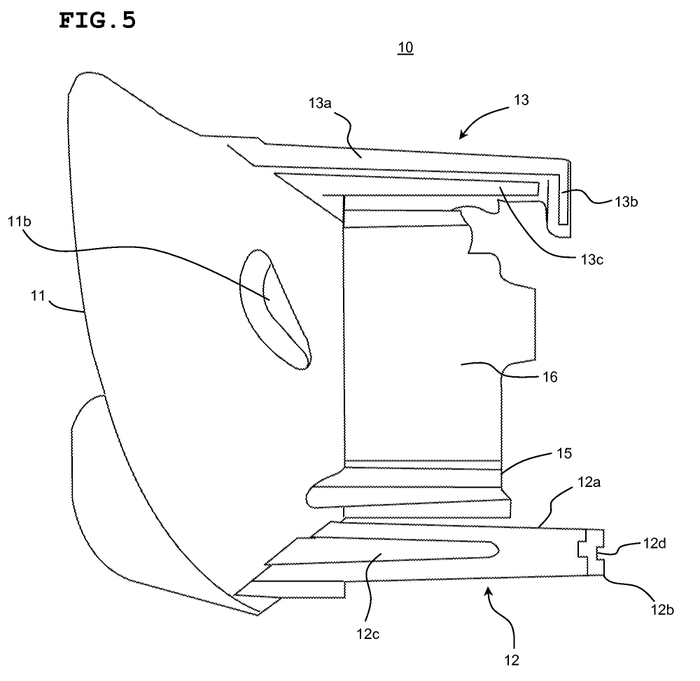

As shown in FIG. 5, the fastening member 12 includes a reinforcing rib 12c which extends along the leg 12a. The reinforcing member 12c is provided to increase the rigidity of the fastening member 12. In the present preferred embodiment, the reinforcing member 12c is preferably a reinforcing rib that extends along a majority of the leg 12a. However, the reinforcing member 12c may have any suitable configuration as long as it increases the rigidity of the fastening member 12. Furthermore, if the fastening member 12 is made of a sufficiently rigid material, the reinforcing member 12c may be omitted.

Similar to fastening member 12, the fastening member 13 preferably includes a foot portion 13b that extends substantially perpendicular to a leg portion 13a. The foot portion 13b is configured to be snap fit into a corresponding structure (not shown) on the knuckle assembly 20 shown in FIGS. 2 and 6 so as to secure the driveshaft boot protector 10 on the knuckle assembly 20. In this preferred embodiment, the foot portion 13b has a substantially rectangular shape. However, the foot portion 13b may have any suitable shape. The foot portion 13b includes a groove 13d that extends along the bottom of the foot 13b. The groove 13d is provided so as to maintain a constant wall thickness, which is preferable for injection molding of the driveshaft boot protector 10. The foot portion 13b and the groove 13d are configured so as to snugly fit against the knuckle assembly 20.

As shown in FIG. 5, the fastening member 13 includes a reinforcing member 13c which extends along the leg portion 13a. The reinforcing member 13c is provided to increase the rigidity of the fastening member 13. In the present preferred embodiment, the reinforcing member 13c is a reinforcing rib that extends along a majority of the leg portion 13a. However, the reinforcing member 13c may have any suitable configuration as long is it increases the rigidity of the fastening member 13. Furthermore, if the fastening member 13 is made of a sufficiently rigid material, the reinforcing member 13c may be omitted.

The fastening member 14 preferably includes two opposing arms 14a and 14b, and a web 14c extending between the arms 14a and 14b. The web 14c is provided to increase the rigidity of the fastening member 14. Each of the two arms 14a and 14b includes a curved end portion configured such that the ends of the arms 14a and 14b are curved towards each other. The specific shape of the end portions of the arms 14a and 14b is not specifically limited, and any suitable shape may be used as long as the end portions of the arms 14a and 14b extend toward each other. In the present preferred embodiment, the web 14c extends from the main body 11 and has a substantially flat plate shape. However, the web 14c may have any suitable shape and configuration as long as it increases the rigidity of the fastening member 14. Furthermore, if the fastening member 14 is made of a sufficiently rigid material, the web 14c may be omitted.

As seen in FIG. 2, when the driveshaft boot protector 10 is mounted on knuckle assembly 20, the fastening member 14 is snap fit around one of the arms 23 of the knuckle assembly 20 so as to secure the driveshaft boot protector 10 to the knuckle assembly 20.

The driveshaft boot protector 10 also includes curved walls 16, 18 which are connected to and extend from the main body 11. The walls 16, 18 are arranged around the periphery of the opening 11a in the main body 11. When the driveshaft boot protector 10 is mounted on the knuckle assembly 20, the walls 16, 18 partially surround the driveshaft 21 and the boot 22. The walls 16, 18 press against the knuckle assembly 20 so as to prevent movement of the driveshaft boot protector 10 in a direction toward the knuckle assembly 20, and the fastening members 12, 13, 14, and 15 are arranged to prevent movement of the driveshaft boot protector 10 in a direction away from the knuckle assembly 20, thus, providing a snap fit. Although two walls 16, 18 are shown in the present preferred embodiment, any suitable number of walls may be provided depending on the design of the driveshaft boot protector 10 and the knuckle assembly 20.

The wall 16 includes the fastening member 15 disposed therein. As seen in FIG. 1, the fastening member 15 preferably has a substantially cylindrical shape for accommodating a fastener therein (not shown). The fastener may be any suitable fastener, such as a screw, a threaded nut, a jam nut, a threaded stud with nut, a pop rivet, a plastic reusable rivet, or a zip tie. The threaded fastener engages a threaded hole in the knuckle assembly 20 when the driveshaft boot protector 10 is mounted on the knuckle assembly 20 so as to secure the driveshaft boot protector 10 to the knuckle assembly 20. Although the fastener 15 according to the present preferred embodiment preferably has a cylindrical shape, any suitable shape may be used, such as a parallelepiped shape, a conical shape, etc.

The present preferred embodiment preferably includes four fastening members 12, 13, 14, and 15; however, any suitable number of fastening members may be used to attach the driveshaft boot protector 10 to the knuckle assembly 20.

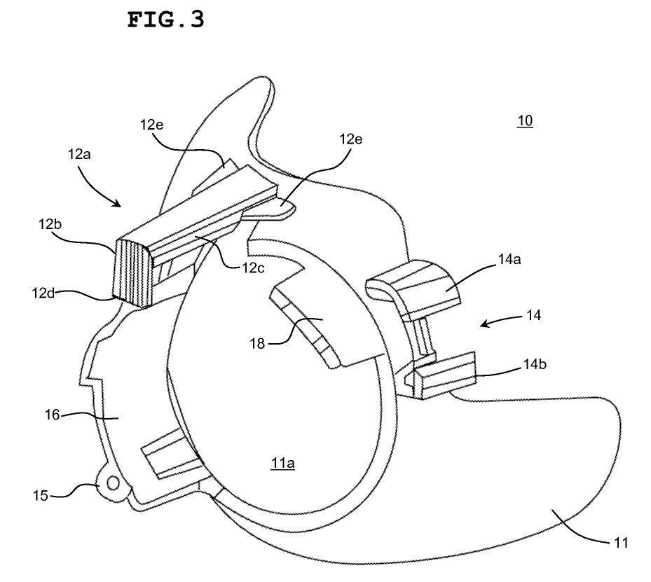

FIG. 3 shows a driveshaft boot protector 10′ according to another preferred embodiment of the present invention. In FIG. 3, elements which correspond to the elements shown in FIG. 1 are denoted by the same reference numerals, and the description thereof is omitted. The driveshaft boot protector 10′ is similar to the driveshaft boot protector 10 shown in FIG. 1, with the exception of the number of fastening members 12, 14, and 15 and the configuration of the reinforcing members 12c and 12e.

In contrast to the driveshaft boot protector 10 shown in FIG. 1, the driveshaft boot protector 10′ preferably includes three fastening members 12, 14, and 15. Alternatively, the driveshaft boot protector 10′ could include any suitable number of fastening members.

In addition to the reinforcing member 12c, the fastening member 12 includes reinforcing members 12e which extend from the main body and along opposed edges of the leg 12a. The reinforcing members 12e are provided to further increase the rigidity of the fastening member 12. Alternatively, any other suitable reinforcing members may be used.

The driveshaft boot protector 10, 10′ according to preferred embodiments of the present invention is preferably made of plastic, and more preferably, made of polyethylene (PE) or polypropylene (PP). However, the driveshaft boot protector 10, 10′ may be made of any suitable material which can be molded, for example, thermoplastic polyolefine (TPO), thermoplastic polyethylene (TPE), acrylonitrile butadiene styrene (ABS), high density polyethylene (HDPE), and nylon.

The main body 11 of the driveshaft boot protector 10, 10′ according to the preferred embodiments of the present invention preferably has a curved shape. However, any suitable shape may be used as long as it surrounds and protects the boot.

The driveshaft boot protector 10, 10′ according to the preferred embodiments described above preferably has a one-piece design. However, the driveshaft boot protector 10, 10′ may include two or more separate pieces, according to the particular design and application of the driveshaft boot protector 10, 10′.

Preferred embodiments of the present invention provide a lightweight, low cost driveshaft boot protector 10, 10′ which allows the boot to be completely protected at all times, including during turning of the vehicle, and during suspension travel. In addition, since the driveshaft boot protector 10, 10′ is connected directly to the knuckle assembly 20, there is no interference between the driveshaft boot protector 10, 10′ and the boot 22, thus, preventing damage to the boot 22 and interference with the operation of the driveshaft 21.

The driveshaft boot protector 10, 10′ may be used on any suitable vehicle, but is preferably used in all terrain vehicles which are driven off-road. The driveshaft boot protector 10, 10′ can be used with any type of vehicle suspension, including a strut suspension configuration, a double A-arm configuration, a trailing arm configuration, and a control arm configuration. The driveshaft boot protector 10, 10′ protects the boot 22 from being damaged by objects such as rocks, brush, logs, and other objects encountered when driving off-road.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A driveshaft boot protector for protecting a driveshaft boot of a knuckle assembly, the driveshaft boot protector comprising:
a main body having a central opening and arranged to at least partially surround the driveshaft boot of the knuckle assembly; and
at least one fastening member extending from a main surface of the main body and being arranged to be removably attached to the knuckle assembly.

2. The driveshaft boot protector according to claim 1, wherein the at least one fastening member includes a leg portion that extends from the main surface of the main body and a foot portion that extends substantially perpendicular to the leg portion, the foot portion being arranged to be engageable with a corresponding structure on the knuckle assembly.

3. The driveshaft boot protector according to claim 2, wherein the at least one fastening member includes a reinforcing member extending along the leg portion to increase the rigidity of the at least one fastening member.

4. The driveshaft boot protector according to claim 1, wherein the at least one fastening member includes at least one first fastening member, at least one second fastening member, and at least one third fastening member each having a different configuration from one another.

5. The driveshaft boot protector according to claim 4, wherein the at least one first fastening member includes a leg portion that extends from the main surface of the main body and a foot portion that extends substantially perpendicular to the leg portion, the foot portion being arranged to be engageable with a corresponding structure on the knuckle assembly.

6. The driveshaft boot protector according to claim 4, wherein the at least one second fastening member has a substantially cylindrical shape extending from the main surface of the main body into which a fastener can be inserted.

7. The driveshaft boot protector according to claim 4, wherein the at least one third fastening member includes at least two opposed arm members and a web extending between the arms.

8. The driveshaft boot protector according to claim 7, wherein each of the at least two opposed arm members includes an end portion that is curved toward the other of the two opposed arm members and are arranged to be engageable with an arm member of the knuckle assembly.

9. The driveshaft boot protector according to claim 1, further comprising at least one wall member extending from the main surface of the main body and being disposed around at least a portion of the periphery of the central opening in the main body.

10. The driveshaft boot protector according to claim 2, wherein the foot portion of the at least one fastening member includes a groove disposed in a bottom surface thereof arranged to be engageable with a rib on the knuckle assembly.

11. A driveshaft boot protector for protecting a driveshaft boot of a knuckle assembly, the driveshaft boot protector comprising:
a main body having a central opening and arranged to at least partially surround the driveshaft boot of the knuckle assembly;
at least one wall member extending from a main surface of the main body arranged to be engageable with the knuckle assembly; and
a plurality of fastening members extending from a main surface of the main body and being arranged to be removably attached to the knuckle assembly.

12. The driveshaft boot protector according to claim 11, wherein at least one of the plurality of fastening members includes a leg portion that extends from the main surface of the main body and a foot portion that extends substantially perpendicular to the leg portion, the foot portion being arranged to be engageable with a corresponding structure on the knuckle assembly.

13. The driveshaft boot protector according to claim 12, wherein the at least one of the plurality of fastening members includes a reinforcing member extending along the leg portion to increase the rigidity of the at least one of the plurality of fastening members.

14. The driveshaft boot protector according to claim 11, wherein at least one of the plurality of fastening members has a substantially cylindrical shape extending from the main surface of the main body into which a threaded fastener can be inserted.

15. The driveshaft boot protector according to claim 11, wherein at least one of the plurality of fastening members includes two opposed arm members extending from the main surface of the main body and a web extending between the arm members.

16. The driveshaft boot protector according to claim 15, wherein each of the two opposed arm members includes an end portion that is curved toward the other of the two opposed arm members arranged to be engageable with an arm member of the knuckle assembly.

17. The driveshaft boot protector according to claim 12, wherein the foot portion of the at least one fastening member includes a groove disposed in a bottom surface thereof arranged to be engageable with a rib on the knuckle assembly.

18. A suspension for a vehicle comprising:
a knuckle assembly; and
a driveshaft boot protector as recited in claim 1; wherein
the driveshaft boot protector is removably attached to the knuckle assembly.

19. A suspension system for a vehicle comprising:
a knuckle assembly; and
a driveshaft boot protector as recited in claim 11; wherein
the driveshaft boot protector is removably attached to the knuckle assembly.

20. A vehicle comprising:
a suspension system including:
a knuckle assembly; and
a driveshaft boot protector as recited in claim 1; wherein
the driveshaft boot protector is removably attached to the knuckle assembly.

21. The suspension system according to claim 18, wherein the driveshaft boot protector is made of a different material from that of the knuckle assembly.

22. The suspension system according to claim 19, wherein the driveshaft boot protector is made of a different material from that of the knuckle assembly.

23. The vehicle according to claim 20, wherein the driveshaft boot protector is made of a different material from that of the knuckle assembly.
